(19) United States
(12) Patent Application Publication
(10) Pub. No.: US 2006/0169807 A1
(43) Pub. Date: Aug. 3, 2006

(54) Powder treatment method, powder treatment device, and powder manufacturing method

(76) Inventors: Junichi Tsuzawa, Takatsuki (JP); Takanobu Masuda, Kitakatsuragi-gun (JP); Toshiaki Kimura, Takarazuka (JP); Shunji Uekado, Kobe (JP)

Correspondence Address: WENDEROTH, LIND & PONACK, L.L.P., 2033 K STREET N. W., SUITE 800, WASHINGTON, DC, 20006-1021, US

(21) Appl. No.: 10/564,834

(22) PCT Filed: Jul. 16, 2004
(86) PCT No.: PCT/JP04/10192

§ 371 Date: Jan. 17, 2006

(30) Foreign Application Priority Data
Jul. 18, 2003 (JP) 2003-276626

(51) Int. Cl. B02C 19/06

(52) U.S. Cl. 241/5; 241/23; 241/40

(57) ABSTRACT

When making powder material ride on gaseous current to move it, the present invention prevents the powder material from fixedly adhering to a wall surface of a treating apparatus.

The present invention concerns a process of treating powder material and an apparatus for treating the same, each of which makes the powder material such as pharmaceutical, ride on gaseous current to move it. In a powder-material treating apparatus (1) such as the jet mill, a heating means (13) is provided along a wall surface (12) to which the powder material collides. This heating means (13) heats the wall surface (12) to not less than approximately a temperature at which the powder material commences to soften and to a temperature lower than a melting temperature of the powder material. And the powder material is made to move while riding on the gaseous current within this powder-material treating apparatus (1).

### TECHNICAL FIELD

The present invention relates to a process of treating powder material used for pharmaceuticals, foods, cosmetics and the like, and to an apparatus for treating the same as well as a method of producing the powder material. More particularly, it concerns a process and an apparatus for treating powder material as well as a method of producing the powder material, each of which prevents the powder material from fixedly adhering to a wall surface of the treating apparatus when making it ride on gaseous current so as to move it.

### BACKGROUND ART

The conventional examples of the treating process for making the powder material ride on gaseous current so as to moving it are, for example, the gaseous-current crushing, gaseous-current transportation, gaseous-current drying, powder-material collection and the like treating processes (for example, see Patent Literature 1). With these processes of treating powder material, it has been known there appears such a phenomenon that the powder material adheres to a wall surface of the apparatus. In the case where this adhesion of the powder material is a general converging and adhesion phenomenon that occurs due to the force of van del Waals, the electrostatic attracting force or the wetting of the surface of the powder material, the adhesion can be prohibited or the adhered substance can be removed relatively easily by preliminarily drying, inhibiting the charge, applying pulse air or impact and vibration to the wall surface, and changing the surface treatment or the material of the wall surface.

However, if the powder material is crushed into fine particles through the jet mill or the like crushing apparatus of gaseous-current type or the powder material is transported at a high speed, for example, of 15 to 30 m/sec., there is caused a case where these powder materials collide against the wall surface to result in strongly and fixedly adhering to the wall surface and further another powder material collides against these fixedly adhered powder materials to thereby grow the substance adhered to the wall surface.

This fixedly adhered substance is increasing in amount, which results in entailing the reduction of the recovery efficiency of the powder material by that increased amount. Besides, since this fixedly adhered substance is so strongly adhered to the wall surface that even if a strong impact or vibration is applied to the wall surface by, for example, a hammer, there is a fear that it is not only easily unremovable but also the impact damages the wall surface.

As the powder material fixedly adheres to the wall surface of each of those treating apparatuses and grows thereon, it narrows inner spaces of the transportation passage and of the crushing chamber to entail a problem that it becomes impossible to adequately carry out the crushing treatment and the transporting treatment. Especially as for the crushing apparatus, if the powder material fixedly adheres to the wall surface in increasing amount, the crushing becomes more insufficient at the same time. Then there is caused a problem that it results in decreasing the treating speed and besides increasing the particle diameter when compared with the time just after the crushing has begun, or the quantity of the uncrushed particles. Further, when the adhered substance scrapes off the wall surface after having grown, there is caused another problem that it becomes so large a mass of foreign matters as to be contaminated into the powder material.

Additionally, when the powder material fixedly adheres to the wall surface, heat is added to the powder material with the result of entailing a fear that the obtained powder material has a reduced degree of crystallization and has the content of analogous substances increased if compared with the pre-treated powder material.

In order to inhibit the powder material from fixedly adhering to the wall surface, it is considered to decrease the speed of the gaseous current. However, there is a case where merely the decrease of the gaseous current speed cannot sufficiently inhibit the secure adhesion of the powder material to the wall surface. Further, it not only reduces the efficiency of treating the powder material but also invites a fear that the powder material cannot be sufficiently crushed into fine particles by the crushing treatment.

Further, as for the material of the wall surface, generally, stainless steel or the like metal material and ceramics material are used. But there is considered a way to form a portion of the wall surface, where the secure adhesion occurs, from a relatively soft organic material like fluororesin so as to prohibit the secure adhesion of the powder material to the wall surface. However, in the event that the material of the wall surface is softened, if the powder material is hard, there is a likelihood that the surface material is worn off at this portion and the worn off substance is contaminated into the treated powder material as impurities.

Therefore, conventionally, in order to remove the fixedly adhered substance, there has been conducted a maintenance work in which the operation of the treating apparatus is stopped and decomposed to dissolve and wash the substance fixedly adhered to the wall surface with proper washing liquid. However, maintenance works of this kind are extremely troublesome and require to frequently interrupt the treatment of the powder material. Thus it was not easy to enhance the treating efficiency.

Patent Literature 1: Patent Public Disclosure No. 9-206620

### DISCLOSER OF THE INVENTION

### The Problem the Invention Attempts to Solve

The present invention has a technical object to solve the above-mentioned problems and to provide a process of treating powder material and an apparatus for treating the same as well as a method of producing the powder material, each of which prevents the powder material from fixedly adhering to the wall surface of the treating apparatus when making the powder material ride on gaseous current so as to move it.

### Means for Solving the Problems

In order to solve the above-mentioned problems, the present invention is constructed, for example, as follows if it is explained based on FIGS. 1 to 3 which show embodiments of the present invention.

A first invention relates to a process of treating powder material, wherein the powder material is made to ride on gaseous current to move within an apparatus 1, 21 for treating the powder material. It is characterized in that a wall surface 12 against which the powder material collides is heated to not less than approximately a temperature at which the powder material commences to soften and to a temperature lower than a melting temperature of the powder material.

A second invention concerns an apparatus for treating the powder material which makes the powder material ride on the gaseous current to move it. It is characterized in that it is provided with a heating means 13, 29 along the wall surface 12 against which the powder material collides and that the wall surface 12 is heated to not less than approximately a temperature at which the powder material commences to soften and to a temperature lower than a melting temperature of the powder material.

A third invention is directed to a method of producing powder material which is accompanied by a procedure for making the powder material ride on gaseous current to move it within the apparatus for treating the powder material 1, 21. It is characterized in: that the apparatus for treating the powder material has a space within which the powder material moves and has a wall surface that opposes to the space and includes a portion to which the powder material fixedly adheres with ease while it is being treated; that the surface portion is heated to not less than approximately a temperature at which the powder material commences to soften and to a temperature lower than a melting temperature of the powder material; and that pre-treated powder material is introduced into this powder-material moving space and is made to ride on gaseous current to move within this powder-material moving space.

When the powder material which moves at a high speed while riding on the gaseous current collides against the wall surface, its energy is converted to generate heat and its surface is softened to adhere to the wall surface. The generated heat is got rid of by the gaseous current which flows around the powder material adhered. Therefore, as it is, the softened powder material has its surface rapidly cooled and solidified. This is considered to result in the strong and secure adhesion of the powder material to the wall surface.

However, the present invention heats the wall surface to not less than approximately the temperature at which the powder material commences to soften, thereby maintaining the portion of the powder material to be adhered to the wall surface at a softened state. Besides, the wall surface has a temperature lower than the melting temperature of the powder material. Accordingly, the powder material is not meltd nor largely deformed. As a result, it is predicted that the powder material readily scrapes off the wall surface when high-speed gaseous current applies pressure to this powder material or other powder material moving with the gaseous current collides thereaginst.

Although there is no likelihood that the powder material is meltd or largely deformed by this heating because the heating temperature is lower than the melting temperature of the powder material, it is preferable to set the temperature as low as possible so as to reduce the influence exerted on the powder material by the heating.

The temperature at which the powder material commences to soften means here a temperature at which a filled layer begins to decrease its volume in the case where the powder material is filled into a cell of a measuring apparatus by using, for example, a flow tester of CFT-500 Model made by Shimazu Seisakusho and then the filled layer is heated to a temperature from 40 degrees C. to 300 degrees C. at a temperature-increase speed of 3 degrees C./min. while pressurizing it from its upper portion with the force of about 4.9 MPa. Further, the expression “approximately the temperature at which the powder material commences to soften” means a temperature within a range of +10 degrees C. to −10 degrees C. from the temperature at which the powder material commences to soften.

The gas which constitutes the gaseous current is not limited to a specific kind but general gas for treating the powder material is used. Air may be used but preferably nitrogen gas and the other inert gas may be employed since they exert only a little influence on the powder material.

The powder material is not limited to that of specific shape and particle-diameter. However, while the powder material which commences to soften at a lower temperature softens easily with the heat generated when it collides against the wall surface, the powder material which has a higher tensile strength readily scrapes off the wall surface. Thus these kinds of powder materials are preferable. For instance, the powder material which commences to soften at not more than about 100 degrees C. under a pressure of about 4.9 MPa or has a tensile strength of not less than about 0.5 MPa easily adheres to the wall surface and therefore the present invention is suitably applicable thereto.

There are various testing methods for measuring the tensile strength. This embodiment adopts the tensile strength in the splitting tensile test at room temperature. Concretely speaking, with a substance molded by compressing 150 mg of powder material under a pressure of 100 MPa into a form of a tablet having a diameter of 8.0 mm taken as a sample, its tensile strength is measured in accordance with the testing method reported by Journal of Pharmaceutical Sciences, volume 59, No. 5, 687 to 691 pages.

However, as for the powder material, generally the powder material which has a melting point of not less than 50 degrees C. is employed. It is preferable to use the powder material which has a relatively high melting point of not less than 150 degrees C. and is stable to heat.

Further, the powder material is not limited to the powder material that is used in the particular field but a preferable powder material is the crystalline organic compound utilized in the field of, for example, pharmaceuticals, foods and cosmetics.

In the case where the powder material is crystalline one, it includes a crystal which contains water of crystallization and a crystalline powder material which comprises a plurality of crystals mixed or is formed into a mixed crystal.

Although these powder materials may each have a high molecular weight, it preferably has a relatively lower molecular weight of not more than 1000 like a powder material as used for pharmaceuticals, foods and cosmetics.

As for the powder material which has been treated by the above-mentioned powder-material treating apparatus, for example, at least 98 wt %, preferably at least 99.0 wt % and more preferably at least 99.5 wt % of the powder material thrown into, for example, this treating apparatus is recovered.

In this case, at least 98.0 wt %, preferably at least 99.0 wt % and more preferably at least 99.5 wt % of the powder material thrown into the powder-material treating apparatus is recovered as the treated powder material which has about the same degree of crystallization as that of the pre-treated powder material. This enhances the productivity of the entire production process and facilitates to retain the quality.

Further, at least 98.0 wt %, preferably at least 99.0 wt % and more preferably at least 99.5 wt % of the powder material thrown into the powder-material treating apparatus is recovered as the treated powder material which has about the same average particle diameter as that of the pre-treated powder material. This enhances the productivity of the entire production process and facilitate to retain the quality as well as the above.

It is sufficient if the powder-material treating apparatus is an apparatus which makes the powder material ride on gaseous current to move it and is not limited to a specific apparatus. But listed as suitable examples are a powder-material crushing apparatus of gaseous-current type, a powder-material transportation apparatus, a powder-material collection apparatus and a powder-material drying apparatus. Also indicated as the crushing apparatus of gaseous-current type is a crusher of circulating-flow type like the jet mill, a crusher of collision-type like the collision-board crusher and a crusher of flow-layer type like the counter-jet mill.

As for the wall surface that opposes to the powder-material moving space within the powder-material treating apparatus, it suffices if it is formed from a material which does not exert a bad influence on the powder material to be applied. Generally, it is formed from stainless steel or the like metal materials and ceramics material. However, needless to say, the wall surface or its surface may be made of fluororesin and the like synthetic resin material depending on the powder material to be used and the using conditions.

As for the heating means provided along the wall surface of the powder-material treating apparatus, it is sufficient if it is able to heat the wall surface to a predetermined temperature, for example, such as an electric heater and is not limited to a specific heating means. However, since this wall surface is brought into contact with the high-speed gaseous current to be cooled, if it is formed from a jacket or a piping passage to which warm or hot water, pressurized water vapor, decompressed water vapor or the like heating medium is supplied, the supplied amount of heat is so large that the wall surface can be easily maintained at a predetermined temperature. Therefore, this is more preferable.

In a method of producing the powder material according to a third invention, the pre-treated powder is crystalline one and the produced powder material is made to have a degree of crystallization which decreases at a ratio within 2.5%, preferably 2.0% and more preferable 1.0% from that of the pre-treated powder material. This facilitates to retain the preservation-stability of the treated powder material. Particularly, in the event that this ratio of decrease is within 2.0%, it can be said that there is little change of quality between the treated powder material and the pre-treated powder material.

In addition, the produced powder material is made to increase the content of the total analogous substances and impurities, for example, at a ratio of less than 0.2 wt %, preferably less than 0.1 wt % and more preferably less than 0.05 wt % when compared with the pre-treated powder material. This can inhibit the reduction of quality by the treatment. Especially, if the ratio of increase is less than 0.1 wt %, it is possible to suppress the influence on the safety and the toxicity.

Besides, the produced powder material is made to increase the average particle diameter at a ratio within 1.5%, preferably 1.0% and more preferably within 0.5% when compared with that of the pre-treated powder material. This simplifies the sieving operation conducted after the treatment. Especially, if the increase ratio is within 1.0%, it is possible to omit the sieving operation after the treatment.

What is called as the analogous substance is a substance produced from the pre-treated powder through decomposition and alternation and is in analogous relationship with the pre-treated powder material.

### Effect of the Invention

Since the present invention is constructed as above, it offers the following effects.

(1) Even if the powder material collides against the wall surface and adhered thereto, this wall surface is heated to not less than approximately the temperature at which it commences to soften and therefore easily scrapes off the wall surface by the pressure of the gaseous current moving at a high speed and the collision of the other powder material moving with this gaseous current, which results in preventing the powder material from strongly and fixedly adhering to the wall surface. Additionally, the wall surface being at a temperature lower than the melting temperature of the powder material, the powder material does not melt nor largely deform. This results in the possibility of dispensing with the washing treatment which has been conventionally required to be frequently done to remove the fixedly adhered powder material to the wall surface so as to facilitate the maintenance work. Besides, it becomes possible to operate continuously for a longer period of time without decreasing the speed of the gaseous current on which the powder material rides and further to keep the treating space of the powder material large with the result of increasing the treating efficiency of the powder material.

(2) Owing to the fact that the powder material is prohibited from fixedly adhering to the wall surface, the treated powder material can be recovered with a greatly increased efficiency with respect to the powder material thrown into this powder-material treating apparatus.

(3) The powder material is inhibited from being excessively heated, for example, to a temperature higher than the melting temperature attributable to the collision against the wall surface while it is being treated. Consequently, it is possible to produce the powder material which has the reduction of degree of crystallization inhibited. Additionally, the generation of decomposition and alternation by the overheat is reduced. Besides, since the wall surface need not be made of a soft material, it is possible to prevent the impurities produced by the abrasion of the wall surface from being contaminated with the result of decreasing the content of the total analogous substances and impurities to be contained in the obtained powder material. Furthermore, for example, in the case of transporting the powder material, the powder material is prohibited from adhering to the wall surface to grow to a large mass. This results in the possibility of producing the powder material which has its average particle diameter inhibited from increasing when compared with the pre-treated powder.

(4) In the event that the treating apparatus is a powder-material crushing apparatus which collides the powder material made to ride on gaseous current positively to the wall surface opposed to the moving space so as to crush it, it is possible to effectively prevent the powder material from fixedly adhering to the wall surface due to the heated surface against which the powder material collides. Therefore, the relative speed of the powder material on collision against the wall surface can be increased to, for example, not less than 300 m/sec. As a result, it is possible to obtain fine particles each of which has a diameter of, for example, not more than 2 μm. In the case where the powder material is pharmaceutical, the original pharmaceutical can be crushed in drying up to have a particle diameter of 500 nm with the result of being able to produce pharmaceutical products excellent in absorbability and solubility.

### BRIEF DESCRIPTION OF THE DRAWINGS

FIG. 1 is a partly broken plan view showing a first embodiment of the present invention applied to a jet mill;

FIG. 2 is a partly broken side view of the jet mill according to the first embodiment; and

FIG. 3 is a schematic diagram showing a second embodiment of the present invention applied to a transportation apparatus of gaseous-current type.

### EXPLANATION OF NUMERALS

1 . . . powder-material treating apparatus (jet mill)
12 . . . wall surface
13 . . . heating means (heating medium jacket)
21 . . . powder-material treating apparatus (transportation apparatus of gaseous-current type)
29 . . . heating means (steam tracing)

### Most Preferred Embodiment for Putting the Present Invention into Practice

Hereafter an explanation is given for embodiments of the present invention based on the drawings.

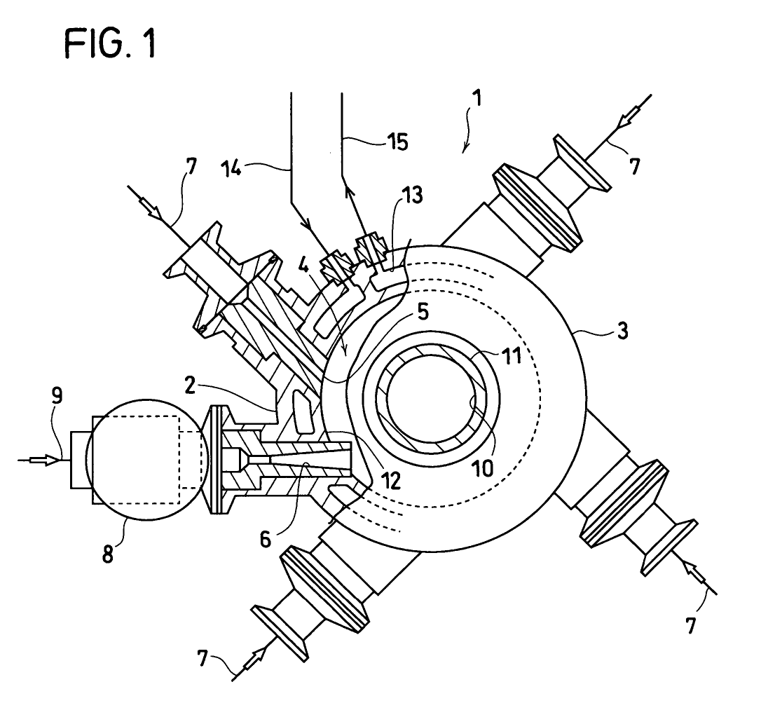

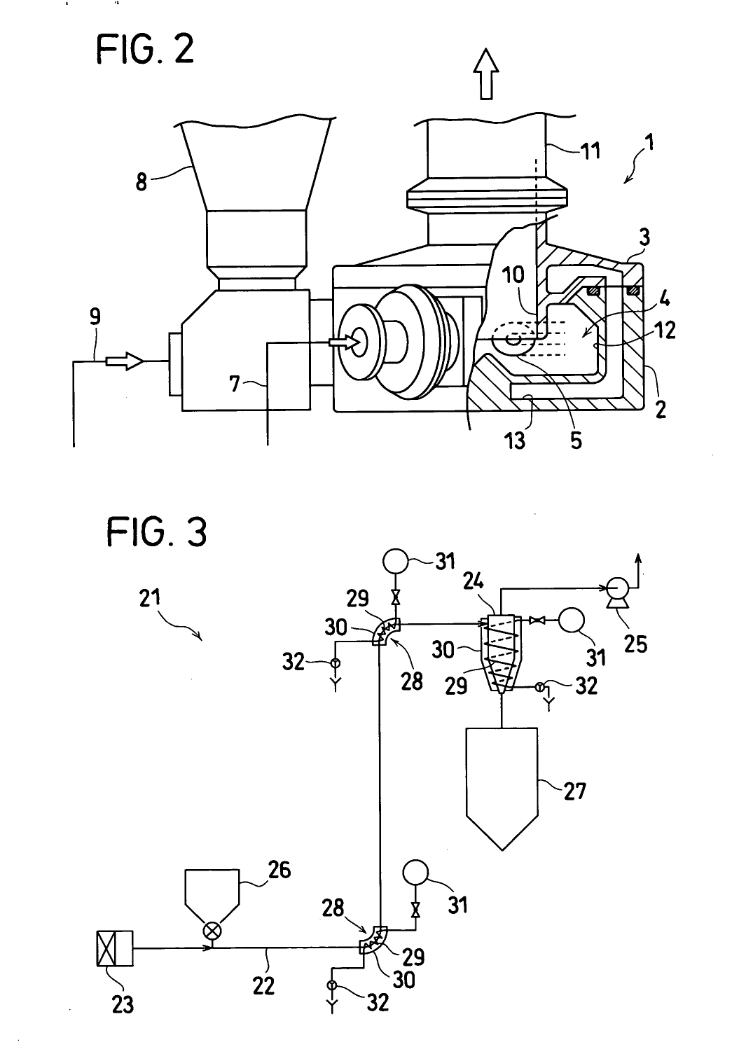

FIGS. 1 and 2 show a first embodiment applied to a jet mill which is a powder-material crushing apparatus of gaseous-current type. FIG. 1 is a partly broken plan view of the jet mill. FIG. 2 is a partly broken side view of the jet mill.

As shown in FIGS. 1 and 2, the jet mill 1 of the powder-material treating apparatus comprises a mill main body 2 in the form of a bottomed cylinder and a closure member 3 placed thereon. The mill main body 2 has an interior area provided with a crushing chamber 4. Further, the mill main body 2 has a peripheral side surface provided with a powder-material supply nozzle 5 which jets the powder material for supply toward an outer peripheral portion of the crushing chamber 4 and with a plurality of gas injection nozzles 6 which inject high-pressure nitrogen gas. Connected to these gas injection nozzles 6 are nitrogen-gas supply passages 7.

In this embodiment, four gas injection nozzles are provided on the peripheral side surface of the mill main body. But, for example, 6 or optional number of gas injection nozzles can be provided. Further, the high-pressure gas supplied through these gas injection nozzles is not limited to nitrogen gas but may employ other gases such as air as far as it does not affect the powder material.

The powder-material supply nozzle 5 is connected to a lower portion of a powder-material supply hopper 8 to which lower portion a gas supply passage 9 for supplying the powder material is connected. Nitrogen gas for supplying the powder material is fed to this supply passage 9.

The crushing chamber 4 has a central portion above which an exhaust port 10 is formed. This exhaust port 10 is connected to an exhaust passage 11.

Each of the mill main body 2 and the closure member 3 has a wall within which a heating medium jacket 13 is formed along a wall surface 12 around the crushing chamber 4, as a heating means. Steam of a predetermined temperature is fed from a heating medium supply passage 14 and is passed through an interior area of the jacket 13 to be discharged through a heating medium discharge passage 15. Although this embodiment employs the steam as the heating medium, warm or hot water, oil or other heating media may be used. Besides, an electric heater or other heating devices may be utilized as the heating means.

Next, an explanation is given for the procedures to crush the powder material into fine particles by using the above-mentioned jet mill.

First, a powder material to be crushed is accommodated into the powder-material supply hopper 8. Utilized for this powder material is crystalline powder pharmaceutical which commences to soften at 48 degrees C., melts at 235 degrees C., has a tensile strength of 1.4 MPa and has an average particle diameter within a range of 50 to some hundreds μm.

The powder material is taken out of the lower portion of the powder-material supply hopper 8 by the nitrogen gas fed to the powder-material supply gas passage 9 and is injected for supply at a high speed into the crushing chamber 4 through the powder-material supply nozzle 5. High-pressure nitrogen gas is injected at a high speed of, for example, 100 to 300 m/sec from the gas injection nozzles 6 into the crushing chamber 4 to form a high-speed circulating gaseous current within the crushing chamber 4. Thus the powder material supplied into this crushing chamber 4 moves within the crushing chamber 4 while riding on this high-speed circulating current and collides against each other to be finely crushed. And the thus resulting fine powder particles, each of which has a diameter of, for example, several μm, are discharged while riding on the nitrogen gaseous current from the discharge port 10 to the discharge passage 11. The powder particles insufficiently crushed to each have a large diameter move on a peripheral portion of the crushing chamber 4 with a centrifugal force and are further continuously crushed.

Steam which comprises low-pressure water vapor adjusted to, for example, about 50 degrees C. is guided into the jacket 13 formed along the wall surface 12 of the crushing chamber 4. In consequence, this wall surface 12 is heated to a temperature slightly higher than 48 degrees C. at which the powder material commences to soften.

The foregoing crushing procedures are efficiently conducted well over a long period of time. The obtained powder material has been uniformly crushed. When removing the closure 3 of the jet mill 1 to confirm the interior area of the crushing chamber 4 after the crushing procedures have been finished, any powder material has not fixedly adhered to the wall surface 12 of the crushing chamber 4 at all.

On the contrary, in order to make a comparison with the above, the powder material of the same kind was crushed under the same conditions except the stopping of supply of the steam to the jacket 13. The crushing efficiency was being progressively lowered. And when removing the closure member of the jet mill to confirm the interior area after the crushing was finished, the powder material strongly and fixedly adhered to the wall surface of the crushing chamber.

Next, an experiment has been carried out to confirm that the powder material is prevented from fixedly adhering to the wall surface by making and using a test machine for confirming whether or not the powder material has fixedly adhered. More specifically, this test machine has a chamber for generating collision, into which compressed air was injected from a jet nozzle at sound speed. The same powder material as mentioned above was supplied for dispersion into the current of this compressed air. This current was made to collide against the wall of the test machine which has a surface temperature heated to a range of 40 to 60 degrees C. Thereafter, the powder material which passed through an interior area of the system of this test machine was recovered by a bag filter disposed downstream of the test machine. Air was discharged through the filter to the atmosphere. About 50 g of the powder material was treated by this way of experiment to find out that the powder material adhered to the wall surface of the test machine at an amount ratio of 0 g/m². Therefore, it was recognized that no powder material fixedly adhered at all.

On the other hand, as a comparison and control experiment, the same powder material as mentioned above was supplied for dispersion in the current of compressed air with the wall of the test machine having a surface temperature maintained lower than room temperature and was made to collide against the wall of the machine. The other conditions were the same as those in the above Example of Experiment. As a result, in this comparison and control experiment, the powder material adhered at an amount ratio of 87.4 g/m² Thus it was recognized that the powder material fixedly adhered.

FIG. 3 is a schematic diagram showing a second embodiment of the present invention applied to a transportation apparatus of gaseous-current type.

As shown in FIG. 3, the transportation apparatus of gaseous-current type 21, a powder-material treating apparatus, is provided with a transportation passage 22 which transports the powder material with air. An air filter 23 is disposed upstream of this transportation passage 22 and a cyclone 24 is connected to a downstream end thereof. A suction blower 25 is connected to the cyclone 24. A powder-material supply hopper 26 is connected to an upstream portion of the transportation passage 22. Further, the cyclone 24 has a lower portion provided with a powder-material receiving hopper 27.

A steam tracing 29 made of a copper tube is spirally wound around each of a bent portion 28 of the transportation passage 22 and the cyclone 24 as a heating means and is covered with a heat insulating material 30. Each of these steam tracings 29 has one end connected to a source 31 for supplying steam 31 and has the other end provided with a steam trap 32.

Next, an explanation is given for the case where the transportation apparatus of gaseous-current type 21 transports the powder material which comprises a raw powder material for flavoring.

This powder material to be transported comprises, for example a mixture formed from two, a first and a second, raw materials each of which is mixed in equal amount. The first raw material commences to soften at 61 degrees C. and melts at 300 degrees C. The second raw material commences to soften at 84 degrees C. and melts at 175 degrees C. However, needless to say, according to the present invention, a powder material of the other kind may be used independently or in mixture.

When the above suction blower 25 is driven, its suction force attracts air into the transportation passage 22 through the air filter 23. The attracted air forms an air current within the transportation passage 22. The air current is flowed into the cyclone 24 to become a circulating current and thereafter is discharged from the suction blower 25 to the atmosphere.

The powder material which comprises powdered flavoring is accommodated within the powder-material supply hopper 26 and is supplied from a lower portion of the supply hopper 26 into the transportation passage 22 by a predetermined amount at each time. Thus this powder material is guided into the cyclone 24 while riding on the air current. As for the conditions of transportation at this time, for example, the powder material is set to have a ratio of mass to flow within a range of 10 to 20 kg-powder/kg-gas and to flow at a speed of 15 to 30 m/sec. And the powder material which has reached the cyclone 24 is separated from the air current circulating within this cyclone 24 to fall down and is received and accommodated within the receiving hopper 27 positioned therebelow.

At least part of the powder material which moves while riding on the air current collides against an inner surface of the bent portion 28 of the transportation passage 22 and an inner peripheral surface of the cyclone 24. But each of this bent portion 28 and the cyclone 24 has a peripheral wall heated to a predetermined temperature higher than approximately the temperature at which the powder material commences to soften, for instance, about 100 degrees C. by the steam to be guided into the steam tracing 29. Thus the powder material which has collided against the wall surface at this portion immediately scrapes off the wall surface and does not fixedly adhere to this portion. As a result, the powder-material transportation could be conducted efficiently for a long period of time. Besides, 99.8 wt % of the powder material thrown into the transportation apparatus of gaseous-current type 21 could be recovered for the powder material having the same degrees of crystallization and average particle diameter as those of the re-treated powder material.

Further, for comparison, under the same conditions except that the heating by the steam was stopped, the powder material of the same kind was transported with air. Then the powder material strongly and fixedly adhered to the inner surfaces of the bent portion and of the cyclone, which entailed the necessity of frequently decomposing and washing the transportation apparatus. Further, in this case, about 97.0 wt % of the powder material thrown into the transportation apparatus of gaseous-current type was recovered for the powder material having the same degree of crystallization and average particle diameter as those of the pre-treated powder material.

The transportation apparatus employed air as the gas for transportation. However, according to the present invention, nitrogen gas or other gases may be utilized. Further, although the steam was used as the heating medium for heating the wall surface, warm or hot water and the like heating media may be employed. Besides, an electric heater and the other heating means may be utilized as the heating means.

Next, an explanation is given for a method of producing powder material accompanied by a moving procedure with the transportation apparatus of gaseous-current type 21.

Used as a pre-treated powder material to be a raw material was a crystallized powder material of pharmaceutical which, for example, commences to soften at 48 degrees C. and melts at 235 degrees C., and has 69.0% of degree of crystallization, an average particle diameter of 4.9 μm, a tensile strength of 1.4 MPa, and 0.42 wt % of content of total analogous substances and impurities. However, according to the present invention, needless to say, the powder material of other kind may be used independently or in mixture of plural kinds.

The pre-treated powder material is accommodated within the powder-material supply hopper 26 and is supplied from the lower portion of this supply hopper 26 into the transportation passage 22 by a predetermined amount at each time. Thus this powder material is guided into the cyclone 24 while riding on the air current. As for the conditions of transportation at this time, for example, the powder material is set to have a ratio of mass to flow within a range of 10 to 20 kg-powder/kg-gas and to flow at a speed of 15 to 30 m/sec. And the powder material which has reached the cyclone 24 is separated from the air current circulating within this cyclone 24 to fall down and is received and accommodated within the receiving hopper 27 positioned therebelow.

At least part of the powder material which moves while riding on the air current collides against the inner surface of the bent portion 28 of the transportation passage 22 and the inner peripheral surface of the cyclone 24. But each of this bent portion 28 and the cyclone 24 has a peripheral wall heated to a predetermined temperature higher than approximately the temperature at which the powder material commences to soften, for instance, about 100 degrees C. by the steam to be guided into the steam tracing 29. Further, in the present invention, the portion to be heated is not particularly limited as far as it is a surface which the moving powder material is collides against and fixedly adheres to with ease when it is not heated. For instance, it is possible to effectively prevent the collision of the powder material occurring on the wall of the machine by heating the portion which the mixture of the gas and the powder material collides against and contacts with, within the transportation apparatus of gaseous-current type and an ejector for supplying the powder material to the crusher. The powder material which has collided against the wall surface at the heated portion immediately scrapes off this wall surface and does not fixedly adhere to this portion. As a result, the powder material which was recovered within the receiving hopper 27 has 69.0% of degree of crystallization, an average particle diameter of 4.9 μm, a tensile strength of 1.4 MPa and 0.45 wt % of content of total analogous substances and impurities. In other words, the obtained powder material had no reduction of the degree of crystallization nor increase of average particle diameter when compared with the pre-treated powder material. The obtained powder material increased the content of total analogous substances and impurities from the pre-treated powder material at a ratio of 0.03 wt %.

Further, for comparison, under the same conditions except that the heating by the steam was stopped, the powder material was produced by using the pre-treated powder material of the same kind. Then the powder material strongly and fixedly adhered to the inner surfaces of the bent portion 28 and of the cyclone 24. The powder material which was recovered within the receiving hopper 27 had 67.0% of degree of crystallization, an average particle diameter of 5.0 μm and a tensile strength of 1.4 MPa. When compared with the pre-treated powder material, it experienced 3% reduction of degree of crystallization and 2% increase of the average particle diameter.

The transportation apparatus employed air as the gas for transportation. However, according to the present invention, nitrogen gas or other gases may be utilized. Further, although the steam was used as the heating medium for heating the wall surface, warm or hot water and the like heating media may be employed. Besides, an electric heater and the other heating means may be utilized as the heating means as mentioned above.

The first and second embodiments employed powdered pharmaceutical and food. But the powder material to be applied to the present invention is not limited to those ones but may be the powder material to be utilized in the other field such as powdered cosmetics.

### INDUSTRIAL AVAILABILITY

The present invention is suitable for the treatment with gaseous current of crushing, transporting, collecting and drying the powder material, which handles pharmaceuticals, foods, cosmetics and the like crystalline powder materials. However, as far as the powder material is treated by moving it while riding it on gaseous current, needless to say, the present invention is applicable even if the powder material is of any kind, is treated for any object and is used in any way.

1. A process of treating powder material by making it ride on gaseous current to move it within a powder-material treating apparatus (1, 21), wherein a wall surface (21) against which the powder material collides is heated to not less than approximately a temperature at which the powder material commences to soften and to a temperature lower than a melting temperature of the powder material.

2. The process of treating powder material as set forth in claim 1, wherein the powder material has a tensile strength of not less than about 0.5 MPa.

3. The process of treating powder material as set forth in claim 1, wherein the powder material commences to soften at a temperature of not more than about 100 degrees C.

4. The process of treating powder material as set forth in claim 1, wherein at least 98 wt % of the powder material thrown into the powder-material treating apparatus (1, 21) is recovered as the powder material treated by this powder-material treating apparatus.

5. The process of treating powder material as set forth in claim 4, wherein at least 98 wt % of the powder material thrown into the powder-material treating apparatus (1, 21) is recovered as the treated powder material having about the same degree of crystallization as that of the pre-treated powder material.

6. The process of treating powder material as set forth in claim 4, wherein at least 98 wt % of the powder material thrown into the powder-material treating apparatus (1, 21) is recovered as the treated powder material having about the same average particle diameter as that of the pre-treated powder material.

7. The process of treating powder material as set forth in claim 1, wherein the powder material is a crystalline organic compound of any one of the pharmaceutical, food and cosmetic.

8. The process of treating powder material as set forth in claim 1, wherein the powder-material treating apparatus (1, 21) is any one of the powder-material crushing apparatus, powder-material transportation apparatus, powder-material collection apparatus and powder-material drying apparatus.

9. An apparatus for treating powder material which makes the powder material ride on gaseous current to move it, wherein a heating means (13, 29) is provided along a wall surface (12) against which the powder material collides so as to heat the wall surface (12) to not less than approximately a temperature at which the powder material commences to soften and to a temperature lower than a melting temperature of the powder material.

10. The apparatus for treating powder material as set forth in claim 9, wherein the heating means (13, 29) is formed from a jacket or a piping passage to which a heating medium is supplied.

11. The apparatus for treating powder material as set forth in claim 9, wherein the powder-material treating apparatus (1, 21) is any one of the powder-material crushing apparatus, powder-material transportation apparatus, powder-material collection apparatus and powder-material drying apparatus.

12. A method of producing powder material accompanied by a procedure for making the powder material ride on gaseous current to move it within a powder-material treating apparatus (1, 21), wherein
a wall surface that opposes to a powder-material moving space within the powder-material treating apparatus (1, 21) has a portion, to which the powder material easily adheres while it is being treated, heated to not less than approximately a temperature at which the powder material commences to soften and to a temperature lower than a melting temperature of the powder material, and
pre-treated powder material is introduced into this powder-material moving space to make it ride on gaseous current to move it within this powder-material moving space.

13. The method of producing powder material as set forth in claim 12, which produces from pre-treated powder material of a crystalline powder material, a powder material having a degree of crystallization reduced at a ratio within 2.5% from that of the pre-treated crystalline powder material, by the movement of the powder material within the powder-material moving space.

14. The method of producing powder material as set forth in claim 12, which produces powder material having the content of total analogous substances and impurities increased at a ratio of less than 0.2 wt % when compared with the pre-treated powder material, by the movement of the powder material within the powder-material moving space.

15. The method of producing powder material as set forth in claim 12, which produces powder material having the average particle diameter increased at a ratio within 1.5 wt % when compared with that of the pre-treated powder material, by the movement of the powder material within the powder-material moving space.
